(19) United States
(12) Patent Application Publication
(10) Pub. No.: US 2021/0254963 A1
(43) Pub. Date: Aug. 19, 2021

(54) BENCHTOP THICKNESS MEASUREMENT DEVICE

(71) Applicant: Co-efficient Precision Engineering Inc., Kanata (CA)

(72) Inventors: Stephen Mate, Nepean (CA); Trent Davin Reeb, Orleans (CA)

(21) Appl. No.: 17/178,665

(22) Filed: Feb. 18, 2021

Related U.S. Application Data
(60) Provisional application No. 62/978,002, filed on Feb. 18, 2020.

(51) Int. Cl. G01B 11/06; G01B 11/02

(52) U.S. Cl. CPC G01B 11/06; G01B 11/026

(57) ABSTRACT

A bench-top device for measuring thickness of a sample includes two distance sensors facing each other across a gap. A sample tray for supporting the sample is positioned in the gap. The distance sensors are attached to arms of a movable frame. An actuator is configured to move the frame in a scan direction orthogonal to the arms.

### CROSS REFERENCE TO RELATED APPLICATIONS

This application claims priority to U.S. Provisional Application Ser. No. 62/978,002, entitled “Benchtop Thickness Measurement Gauge”, filed Feb. 18, 2020, the disclosure of which is incorporated by reference herein.

### FIELD

The present disclosure generally relates to thickness measurement devices and methods, and more particularly relates to a benchtop thickness measurement device.

### BACKGROUND

A benchtop gauge for accurately measuring a thickness of an object may include one or more laser spot sensors mounted to a c-frame structure. The laser spot sensors are commonly used devices that transmit a small beam of laser light, and detect the location where the light hits the surface to calculate the distance using a triangulation principle. Each sensor reports its own distance reading. The c-frame structure is convenient to keep both laser spots on opposite sides of the sample coincident with one another so that the sample's thickness is accurately measured. The laser spots approach the sample, one from the top, and one from the bottom, and the distance measurement from each sensor is subtracted from the known spacing of the sensors, resulting in the thickness of the sample at the location where the laser spots are pointed.

The method of combining two laser sensors to measure thickness may be used for both inline and offline measurements. Inline measurements are measurements taken on a web material, e.g. in the form of a continuous sheet or strip, moving in a production line. Offline measurements are taken when an operator manually places a sample to be measured onto the gauge. In some cases samples may be placed onto a sample tray of an offline gauge automatically by a machine. A gauge used for these offline measurements may be called a benchtop gauge or a benchtop thickness measurement apparatus. The disclosure below primarily relates to offline, or benchtop, thickness gauges.

### SUMMARY

An aspect of the present disclosure relates to a benchtop thickness measuring gauge having a reduced footprint.

An aspect of the present disclosure provides a thickness measuring apparatus, comprising: a frame comprising two opposing arms extending in an arm length direction with a gap therebetween, and two distance sensors mounted to the two opposing arms facing each other across the gap and configured to measure distances to opposite sides of a sample when the sample is disposed in the gap. The apparatus further comprises a platform disposed partly in the gap for supporting the sample, and an actuator is configured to move the frame in a first measurement direction that is substantially orthogonal to the arm length direction of the frame.

The two opposing arms may have a first end and a second end, and may be connected at least at the first ends thereof with a connecting section to form a C-frame or an O-frame. In some implementations a distance between the platform and the connecting section of the frame does not change when the frame is moved in the first measurement direction.

In some implementations the platform is configured to remain stationary during a thickness measurement when the frame is moved in the first measurement direction.

In some implementations the actuator may be configured to move the frame or the platform in a second scan direction that is substantially parallel to the arm length direction.

In some implementations at least one of the distances sensors comprises a laser spot sensor.

In some implementations at least one of the distances sensors comprises a laser spot sensor disposed to direct a light beam onto a surface of the sample that is proximate to the laser spot sensor.

In some implementations each of the two distance sensors comprises a laser sensor. In some implementations at least a portion of the platform between the laser sensors may be substantially transparent to light from the laser sensors.

In some implementations the platform may have a flat surface for supporting the sample. In some implementations the platform comprises an aperture positioned in a path of light from one of the distance sensors distal from the flat surface for supporting the sample. The aperture may be configured to allow the light to illuminate the sample through the aperture when the frame is moved in the first measurement direction. In some implementations the aperture is in the form of a slit extending in the first measurement direction.

In some implementations the actuator is further configured to move the frame in a second scan direction that is generally perpendicular to the first measurement direction.

In some implementations the platform has an aperture or a see-through window positioned in a path of light from one of the distance sensors distal from a sample-supporting surface of the platform, the aperture or the see-through window configured to allow the light to scan across a rectangular area of the sample through the aperture or the see-through window when the frame is moved in the first and second scan directions.

An aspect of the disclosure provides a benchtop thickness measuring apparatus, comprising: a frame comprising two opposing arms extending in an arm length direction with a gap therebetween, the frame comprising two distance sensors mounted to the two opposing arms facing each other across the gap and configured to measure distances to opposite sides of a sample when the sample is disposed in the gap; a platform disposed partly in the gap for supporting the sample; and an actuator configured to move at least one of the frame and the platform in a first scan direction that is substantially orthogonal to the arm length direction of the frame.

### BRIEF DESCRIPTION OF THE DRAWINGS

Embodiments disclosed herein will be described in greater detail with reference to the accompanying drawings which represent example embodiments thereof, in which like elements are indicated with like reference numerals, which are not to scale, and wherein:

FIG. 1A is a schematic isometric view of a benchtop gauge having a c-frame orientated in a scan direction, with the distance sensors retracted into a housing;

FIG. 1B is a schematic isometric view of the benchtop gauge of FIG. 1A, with the distance sensors in an extended position;

FIG. 2A is a schematic isometric view of a benchtop gauge with a scan-orthogonal c-frame orientation, with the c-frame in a first scan position;

FIG. 2B is a schematic diagrams of the benchtop gauge of FIG. 2A, with the c-frame in a second scan position;

FIG. 3 is a schematic isometric view of a c-frame assembly perpendicularly mounted to a linear actuator;

FIG. 4 illustrates a side view of a c-frame with a sample tray supporting a sample between the arms of the c-frame;

FIG. 5 illustrates a side view of an example o-frame;

FIG. 6 is a schematic diagram illustrating a top view of an example sample tray with a an aperture allowing for two-dimensional scanning of a rectangular area of a sample.

### DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Reference throughout this specification to “one embodiment” or “an embodiment” means that a particular feature, structures, or characteristics may be combined in any suitable manner in one or more embodiments. As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated. “Or” is used herein in non-exclusive sense, so that an expression “A or B” does not exclude “both A and B”, unless explicitly stated otherwise.

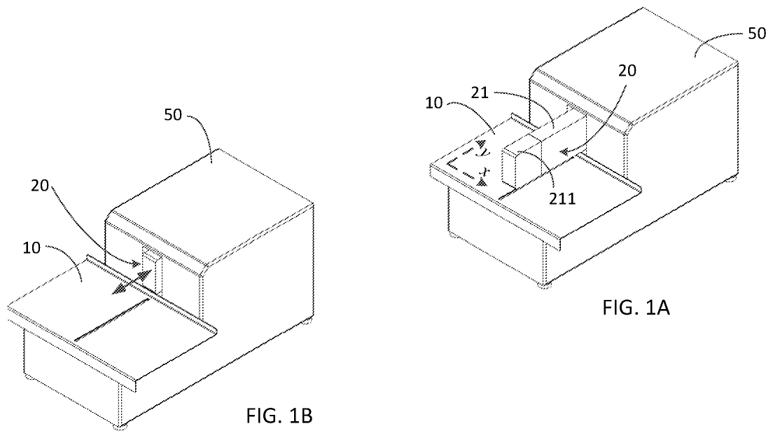

FIGS. 1A and 1B illustrate a first example embodiment of a benchtop thickness gauge. A c-frame subassembly 20 includes one or more distance sensors 211 mounted to respective arms 21, 22 of the c-frame facing each other across a gap between the arms. The c-frame 20 may be mounted to a linear actuator (not shown) disposed in a housing 50 for the purposes of automatically scanning a sample placed on a sample tray 10. The linear actuator may be a motorized system that moves the entire c-frame and sensors subassembly 20. Samples measured are commonly, but not exclusively, thin, flat plates, or strip materials. There are many advantages to products that use the scanning method as many thousands of points per second can be measured by laser sensors 211, resulting in the customer benefiting from measuring the entire thickness cross-section quickly. A processor running suitable software may then be used to compute statistical meaningful information such as the average thickness, peak thickness, and shape of the product, and surface imprints or other dimensional features that may exist. Such benchtop gauges may be operated by placing the sample onto the sample tray 10, the c-frame 20 scanning across the sample (not shown), and then the operator reading the thickness values from a read-out screen of the gauge. The gauge may include a suitable processor. The gauge may further include a memory that may store thickness readings to a file or a database, which may be shown as history of readings.

In the embodiment of FIGS. 1A and 1B the measurements may be limited to scanning along one cross-sectional line across the sample extending in a length direction of the arms of the c-frame 20, which is an y-axis direction as illustrated in FIG. 1A. In FIGS. 1A and 1B, only the top c-frame arm 21 with a top sensor 211 mounted thereto are visible. FIG. 1A illustrates a state of the gauge with the arms of the c-frame 20 extended over tray 10 in a measurement position, while FIG. 1B illustrates a state of the gauge with the arms of the c-frame 20 retracted into a housing 50. The state shown in FIG. 1B may be an idle state of the gauge.

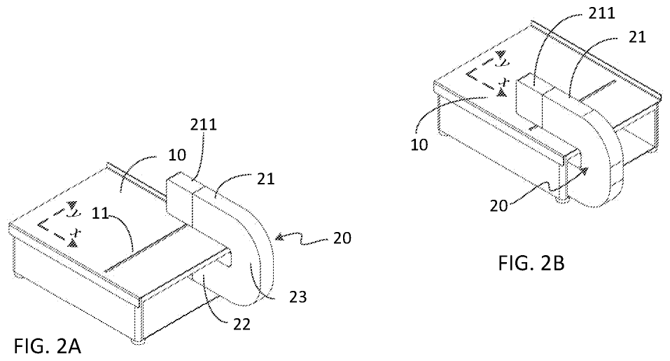

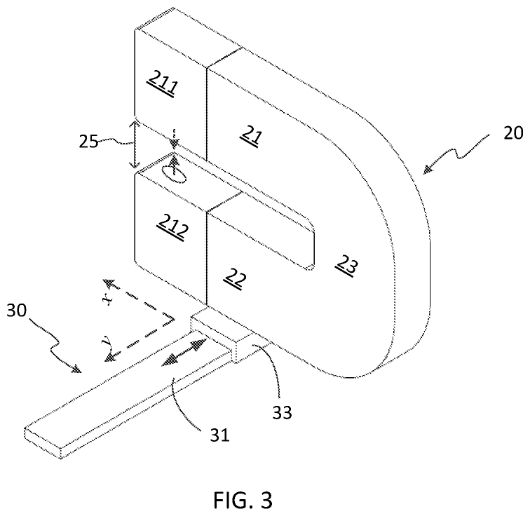

FIGS. 2A, and 2B illustrate an embodiment of a thickness measuring apparatus with a different orientation of the c-frame 20 relative to the direction of frame travel during a measurement scan. In some embodiments the c-frame 20 may be coupled to a linear actuator, e.g. as illustrated in FIG. 3. A sample tray 10 is positioned partly in the jaw of the c-frame 20, i.e. in a gap 25 (FIG. 3) between the arms 21, 22 thereof. The sample tray 10 may have a flat top surface for positioning a sample (not shown) thereon. While in the embodiment of FIGS. 1A and 1B the jaw of the c-frame 20, which is formed by the arms 21, 22 thereof, is oriented in the direction of travel during a measurement scan, shown as the y-axis, in the embodiment of FIGS. 2A and 2B the jaw of the c-frame 20 is rotated by substantially 90-degrees relative to the axis of frame motion (y-axis), and is oriented with the arms or jaw of the frame 20 along the x-axis. During a scan, the c-frame assembly 20 may move by the actuator in a first scan direction, i.e. the y-axis direction in the figures, between right-most and left-most positions illustrated in FIG. 2A and 2B, respectively. In this embodiment, the first scan direction (y-axis) is substantially orthogonal to the arms-length direction of the c-frame 20 (x-axis). Here “substantially orthogonal” or “substantially perpendicular” mean an orientation at 90+\−10 degrees. In one embodiment the sample tray 10 may have a see-through aperture, such as a through slit 11 oriented along the first scan direction and positioned to allow access to the sample for the second, or lower, sensor 212 that is mounted at the lower arm 22 of the c-frame 20 (FIG. 3), with the lower sensor 212 being proximate to a side of tray 10 opposite from the sample side. In some embodiments the sample tray 10, or at least a portion thereof that may be moved between the sensors during the scan, may be substantially transparent for the sensors, so that slit 11 is not required. The sample tray 10 may or may not have raised edges and may also be referred to as the (sample) support or the (sample) platform.

Similarly to the gauge of FIGS. 1A and 1B, the gauge of FIGS. 2A and 2B may be capable of measuring the thickness of a sample on the tray 10 at many thousands of points per second, so that the entire thickness cross-section may be measured quickly. The gauge may include a processor (not shown) running suitable software that may be configured to compute statistical meaningful information such as the average thickness, peak thickness, and shape of the product, and surface imprints or other dimensional features that may exist on a sample. Such benchtop gauges may be operated by placing a sample (not shown) onto the sample tray 10, the c-frame 20 scanning across the sample in the first scan direction. An operator may read the thickness values from a read-out screen of the gauge (not shown). The gauge may further include a memory that may store thickness readings to a file or a database, which may be shown as history of readings.

The arrangement of FIGS. 2A and 2B, in which the c-frame 20 travels during measurements in a direction substantially perpendicular to the length direction of the arms 21, 22 or jaw thereof, has an advantage of significantly reducing the footprint size of the benchtop gauge. The reduced space occupied by the gauge may be of a significant importance to the customer, in particular when the gauge is used in a location, such as a manufacturing floor, or a laboratory, where space is typically limited. Furthermore, a smaller gauge can be more easily positioned at a convenient location close to the operator. Other benefits from a smaller sized gauge include reduce weight, which makes it easier to package, ship, place and handle.

FIG. 3 illustrates an example c-frame 20 orthogonally mounted on a linear actuator 30, which includes a frame support 33 that is movable along a rail 31 in the y-axis direction during a measurement scan. The c-frame assembly 20 is oriented substantially perpendicularly to the direction of motion during a thickness measurement scan, with its two measurement arms 21, 22 extending in the arm-length direction along the x-axis. In the illustrated example the two sensors 211, 212 are mounted at the ends of the opposing arms 21, 22 of the c-frame 20 facing each other to measure distances to opposite sides of a sample when the sample is disposed in the gap 25 between the sensors. In some embodiments sensors 211, 212 may be positioned at opposing surfaces of the respective arms 21, 22 facing each other, or be embodied within the arms facing each other. Sensors 211, 212 may be, for example, laser based sensors, such as but not exclusively laser spot sensors as known in the art. In some embodiments they main include a laser emitting light beam into the gap 25 between the measurement arms, and a detector array disposed to measure the spot size or location of reflected light. The lasers of the sensors 211 and 212 may be aligned to illuminate a substantially same (x, y) location on a sample from opposing sides thereof. Other sensors capable of accurately measuring small distances may also be used. The linear actuator 30 may be, for example, an electromechanical actuator, hydraulic actuator, pneumatic actuator, mechanical actuator, or any other suitable linear actuator.

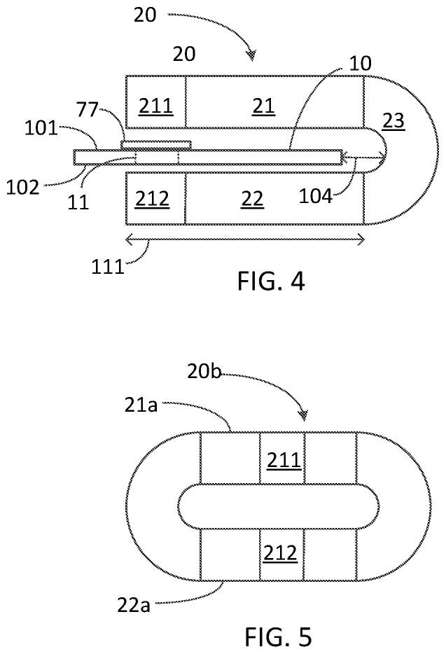

Referring now to FIGS. 3 and 4, in some embodiments the linear actuator 30 may be oriented so that the distance 104 between the connecting section 23 of the c-frame 20 and the sample tray 10 is small, e.g. from a few millimeters (mm) to a few centimeters (cm), and does not change substantially during a linear scan in the first scan direction (y-axis). The length 111 of the measurement arms 21, 22 of frame 20 may vary depending on application, with the shorter arms 21, 22 providing a more compact design, and longer arms 21, 22 enabling measuring samples of greater size. The size of the gap 25 may also depend on the sample size. By way of non-limiting example, the length 111 of the arms 21, 22 may be in the range from about 10 cm to about 40 cm, and the gap 25 may be in the range from 10 mm to 100 mm.

FIG. 4 schematically shows a sample 77 positioned on a flat top surface 101 of a tray 10, which is in turn positioned partly in the gap 25 between the arms 21, 22 of the frame 20. Sensors 211, 212 may be laser sensors, e.g. laser spot sensors, with the lower sensor 212 being proximate to the tray 10, and proximate to a lower surface 102 of the tray that is opposite to the sample-supporting surface 101 thereof. The tray 10 is positioned with the aperture 11 aligned with the sensor 212 and in the optical path of the laser light, to allow the light from sensor 212 illuminate the lower surface of the sample 77. The aperture 11 may be for example a through slit in the tray 10 as described above. In some embodiments at least a portion of the tray 10, such as the portion of the tray that is between the sample 77 and the lower sensor 212 during a measurement scan, may be substantially transparent to the light from the sensor 212. Here “substantially transparent” means sufficiently transparent to the light from the sensor 212 to allow the sensor 212 to reliably measure the distance to the lower surface of the sample 77 through the tray 10. For example, it may correspond to transmission of at least 50%, or at least 80% of the incident light's power.

In some embodiments the c-frame 20 may be replaced with an o-frame 20b illustrated in FIG. 5, which includes measurement arms 21a and 21b that are connected to each other at both ends, or may be any other suitable frame. In some embodiments a frame with a single arm may be used, such as the arm 21 on which one or more distance sensors 211 may be mounted. The sensors may measure the distance to the proximate sample surface, which then may be subtracted from a distance to the tray, which may be co-measured or stored as a calibration parameter.

Although it may be preferred that the measurement arms 21, 22 of frame 20 are oriented perpendicularly to the first scan direction (y-axis), it will be appreciated that some tolerance may be allowed, for example +\−10 degrees, or even +\−30 degrees or greater in some embodiments. Generally, even a 45 degrees orientation of the c-frame relative to the scan direction may allow for some footprint saving.

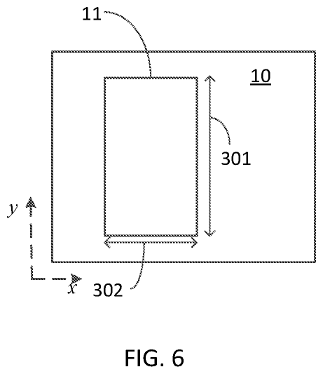

In some embodiments, one or more linear actuators may be used to move the frame along two different directions to obtain a 2D surface scan of a sample. For example, the actuator 30 may be mounted to a support frame of a second linear actuator oriented perpendicularly to the actuator 30 so as to move the frame in a second scan direction that is substantially orthogonal to the first scan direction, to provide an (x, y) distance or thickness scan. In such embodiments, the aperture 11 may be of a generally rectangular shape, as schematically illustrated in FIG. 6. In some embodiments, the aperture 11 may be of a shape that may differ from rectangular, but configured to allow the sensor light to scan across a rectangular area of the sample through the aperture 11, when the frame is moved in the first and second scan directions. In some embodiment, the aperture 11 may be replaced with a suitably shaped see-through window that is substantially transparent to the sensor light.

In some embodiments the scan distance 302 in the second scan direction, i.e. along the arms of the frame (x-axis), may be smaller than the scan distance 301 in the first scan direction, i.e. perpendicular to the arms of the frame (y-axis), which may reduce the overall footprint of the device. The scan distances 301, 302 may define the dimensions of the aperture in the scan directions.

As stated above, an advantage to this configuration is a significant space saving, approaching half the size of the parallel design illustrated in FIGS. 1A, 1B. The design, wherein the linear actuator is substantially orthogonal to the arm-length direction of the frame, may have further advantages, e.g. that debris shed from the samples being measured no longer land on the linear actuator, nor is it drawn into the housing of the gauge where it can contaminate the electrical and mechanical components. In the embodiment of FIGS. 2A, 2B, and 3, the debris would pass through the slit 11 (FIGS. 2A, 2B) and onto to a table on or a clean-out tray below the gauge.

The above-described exemplary embodiments are intended to be illustrative in all respects, rather than restrictive, of the present invention. Indeed, various other embodiments and modifications to the present disclosure, in addition to those described herein, will be apparent to those of ordinary skill in the art from the foregoing description and accompanying drawings. For example, instead of moving the frame with the sensors during a measurement scan, embodiments may be envisioned in which the sensors remain stationary and the sample tray is moving. In some embodiments the linear actuator may be configured to move the sample tray while the sensors bearing frame remains stationary during a measurement scan. In some embodiments both the tray and the frame may be moving during a scan, for example along orthogonal axes. In some embodiments, at least one of the upper arm 21 and the lower arm 22 of the frame may include two or more distance sensors, such as two or more laser spot sensors. Some embodiments may utilize rotary actuators in addition to linear actuators, e.g. to spin the sample tray during a measurement. Some embodiments may use distance sensors other than laser spot sensors, such as for example but not exclusively line laser sensors, inductive (eddy current) sensors, ultrasound sensors.

Furthermore in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Furthermore, it will be appreciated that each of the example embodiments described hereinabove may include features described with reference to other example embodiments.

Thus, while the present invention has been particularly shown and described with reference to example embodiments as illustrated in the drawing, it will be understood by one skilled in the art that various changes in detail may be affected therein without departing from the spirit and scope of the invention as defined by the claims.

We claim:

1. A benchtop thickness measuring apparatus, comprising:
a frame comprising:
two opposing arms extending in an arm length direction with a gap therebetween, and
two distance sensors mounted to the two opposing arms facing each other across the gap and configured to measure distances to opposite sides of a sample when the sample is disposed in the gap;
a platform disposed partly in the gap for supporting the sample; and,
an actuator configured to move the frame in a first scan direction that is substantially orthogonal to the arm length direction of the frame.

2. The benchtop thickness measuring apparatus of claim 1 wherein the platform is configured to remain stationary during a thickness measurement when the frame is moved in the first scan direction.

3. The benchtop thickness measuring apparatus of claim 1 wherein the actuator is further configured to move the frame in a second scan direction that is substantially parallel to the arm length direction.

4. The benchtop thickness measuring apparatus of claim 2 wherein each of the two opposing arms has a first end and a second end, wherein the two opposing arms are connected at least at the first ends thereof with a connecting section to form a C-frame or an O-frame.

5. The benchtop thickness measuring apparatus of claim 4 wherein a distance between the platform and the connecting section of the frame does not change when the frame is moved in the first scan direction.

6. The benchtop thickness measuring apparatus of claim 1 wherein at least one of the distances sensors comprises a laser spot sensor.

7. The benchtop thickness measuring apparatus of claim 1 wherein at least one of the distances sensors comprises a laser spot sensor disposed to direct a light beam onto a surface of the sample that is proximate to the laser spot sensor.

8. The benchtop thickness measuring apparatus of claim 1 wherein each of the two distance sensors comprises a laser sensor.

9. The benchtop thickness measuring apparatus of claim 8 wherein at least a portion of the platform between the laser sensors is substantially transparent to light from the laser sensors.

10. The benchtop thickness measuring apparatus of claim 8 wherein the platform has a flat surface for supporting the sample.

11. The benchtop thickness measuring apparatus of claim 10 wherein the platform comprises an aperture positioned in a path of light from one of the distance sensors proximate to the platform and configured to allow the light to illuminate the sample through the aperture when the frame is moved in the first scan direction.

12. The benchtop thickness measuring apparatus of claim 10 wherein the aperture is in the form of a slit extending in the first scan direction.

13. The benchtop thickness measuring apparatus of claim 1 wherein the actuator is further configured to move the frame in a second scan direction that is generally perpendicular to the first scan direction.

14. The benchtop thickness measuring apparatus of claim 13 wherein the platform has an aperture or a see-through window positioned in a path of light from one of the distance sensors distal from a sample-supporting surface of the platform, the aperture or the see-through window configured to allow the light to scan across a rectangular area of the sample through the aperture or the see-through window when the frame is moved in the first and second scan directions.

15. A benchtop thickness measuring apparatus, comprising:
a frame comprising:
two opposing arms extending in an arm length direction with a gap therebetween, and
two distance sensors mounted to the two opposing arms facing each other across the gap and configured to measure distances to opposite sides of a sample when the sample is disposed in the gap;
a platform disposed partly in the gap for supporting the sample; and,
an actuator configured to move at least one of the frame and the platform in a first scan direction that is substantially orthogonal to the arm length direction of the frame.
